(19) United States
(12) Patent Application Publication
(10) Pub. No.: US 2024/0051161 A1
(43) Pub. Date: Feb. 15, 2024

(54) MULTI-LINK CUTTING PLIER

(71) Applicant: BLACK & DECKER INC., New Britain, CT (US)

(72) Inventors: David P. ENGVALL, Stanley, NC (US); Pavel DUGIN, Catonsville, MD (US); Joshua J. AIKEN, Eldersburg, MD (US); Robert S. GEHRET, Hampstead, MD (US)

(21) Appl. No.: 18/298,197

(22) Filed: Apr. 10, 2023

Related U.S. Application Data
(60) Provisional application No. 63/362,689, filed on Apr. 8, 2022.

(51) Int. Cl. B26B 17/02

(52) U.S. Cl. CPC B26B 17/02

(57) ABSTRACT

A multi-link cutting tool used to cut wire, pipe, cable, tube, chain and the like. The cutting tool utilizes a multi-link connecting linkage between the cutting jaw and the handles to increase the leverage obtained at the cutting edge, to control the relative motion of the jaws, and/or use to control the motion of the cutting edge. With this multi-link connecting mechanism, a smaller and more powerful cutting tool can be made.

### I. FIELD OF THE INVENTION

The present invention relates to a cutting tool of the type used to cut a variety of materials such as wire, cable, pipe, tube, chain and the like. More particularly it relates to a number of linkages used in a cutting tool to increase the leverage obtained at the cutting edge and/or a number of linkages used to control the relative motion of the jaws.

### II. BACKGROUND OF THE INVENTION

Traditionally, the jaws of cutting tools move in rotation about a single axis, for example a rivet or bolt, rotatably connected to both jaws. The relative motion of the jaws has a single degree of freedom in rotation, also referred to as pure rotation.

Cutting tools also typically have a cutter head with two jaws each of which is provided with a cutting edge and each of which is attached, typically by a bolt, to its own handle. The jaws are positioned in an opposing relationship to each other and are held together in this position by straps, usually metal straps, located on the top and bottom of the jaws. The straps are bolted to the jaws, and lock plates, also usually of metal, are normally mounted over the straps and are also bolted to the jaws. Typically, one bolt is used for each jaw to hold the straps and the lock plates in place on both sides. This bolt passes through a hole in the jaw. In operation, pressure on the handles of the cutting tool which are connected to the jaws causes them to turn around the bolts therethrough such that each jaw pivots around the axis through the center of its bolt. Thus, the jaws are rotated in opposite directions around separate centers of motion.

Thus, when a wire or cable is cut, the arc through which a handle moves is only a certain degree. As a result, a greater force is required on the handle to receive the same total leverage at the cutting edge. Total leverage is defined as the ratio of the force at the cutting edge to the force at the end of the handle.

It would be desirable, therefore, if there was a cutting tool which overcame the disadvantages of existing cutting tools and enabled the user to exert less force on the handle but through a number of linkages used to control the relative motion of the jaws, number of linkages used to control the cutting edge of the jaws, and/or increased cutting leverage to achieve the total leverage necessary to cut a variety of materials.

### III. SUMMARY OF THE INVENTION

Generally, the present invention provides a smaller and more powerful cutting tool by using a number of connecting linkages for effecting the relative movement between the jaw members caused by the forces exerted on the handles of the cutting tool. The present invention comprises a pair of handles connected to a cutter head subassembly by a number of connecting linkages.

In at least one embodiment of the present invention, there are connecting linkages that can include a number of connecting members or links, such as four connecting links. In the invention there is a first link at one end that is connected to the first handle and at the other end to a pivot pin. Similarly, a second link at one end is connected to the second handle and at the other end to the same pivot pin as the first link. A third link connects the pivot pin with the end of the first jaw member which is away from the cutting edge. Similarly, the fourth link connects the pivot pin with the end of the second jaw member which is away from the cutting edge. The four links can all be fixed at one end to either the handle or the jaw member to which they are attached but can pivot about the pivot pin to which the other ends are attached. In other embodiments, links are connected in parallel or at angles, respectively, to provide greater structural stability when the connecting linkage is transmitting the force on the handles to the cutting edges. In operation, the opposing movement of the handles can cause a push-pull movement of the pivot pin along the longitudinal axis of the cutting tool which opens and closes the jaw members.

In at least one embodiment of the present invention there is included a multi-link cutting tool including a cutting jaw; a first and second handle, each of which is held in position and pivots about an area of the cutting jaw; and a number of connecting linkages between each handle and the cutting jaws including: a first link connecting the first handle and a pivot pin; a second link connecting the second handle and a pivot pin; a third link connecting a pivot pin and a first jaw member of the cutting jaw; and a fourth link connecting a pivot pin and a second jaw member of the cutting jaw.

In at least one embodiment of the present there is included a plier tool comprising: a pair of jaws including an edge, two links connected to the pair of jaws, wherein at least one end of a link is rotatably connected to the top jaw and wherein at least one end of a link is rotatably connected to the bottom jaw, the at least two links can having a straight line perpendicular to and intersecting with the axis of rotation at an end of a link, wherein the line of action extends beyond the ends of the links, and one point of intersection between the line of action of a tension link and the line of action of a compression link defines the momentary center or instantaneous center of rotation of all parts of the mechanism, and wherein the momentary center of rotation moves as the mechanism is articulated resulting in a motion between the top jaw and the bottom jaw.

In at least one embodiment of the present invention, force applied on exterior surface of the handles directs a number of connecting linkages to increase the cutting leverage onto at least one jaw.

In at least one embodiment of the present invention, there is included a number of linkages connected to the plier jaws used to control the relative motion of the jaws.

In at least one embodiment of the present invention, there is included a number of linkages connected to the plier jaws used to provide more motion to control jaw edges to actuate slicing action as opposed to pinching action of the jaws.

It is an objective of this present invention is that the tool handles may be spread in a reduced fashion apart from one another while also providing increased cutting strength.

It is an object of the present invention to provide cutting pliers to increase the cutting jaw leverage and/or strength without an excessively large hand span.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### IV. DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 is a perspective view of a cutting plier device according to a first embodiment of the present invention.

FIG. 2 is a top view of the cutting plier of FIG. 1.

FIG. 3 is a top, cross-section view of the cutting plier of FIG. 2.

FIG. 4 is a side, cross-section view of the cutting plier device of FIG. 1.

FIG. 5 is a bottom view of the cutting plier device of FIG. 1.

FIG. 6 is a side view of the cutting plier device of FIG. 1.

FIG. 7 is a top, cross section view of the cutting plier device of FIG. 2.

FIG. 8 is another side, cross section view of the cutting plier device.

FIG. 9 is a top view of the cutting plier device of FIG. 7.

FIG. 10 is a side view of the cutting plier device of FIG. 8.

FIGS. 11-14 are a number of perspective views of the cutting plier device of FIG. 1.

FIG. 15-16 are exploded views of the cutting plier device of FIG. 1.

FIG. 17 is a cross section view of the cutting plier.

FIGS. 18A-18D are views of the cutting plier opening at various stages to operate or cut on a wire, pipe, cable, tube, chain and the like.

FIGS. 19A-19B are views of the cutting plier having a wire between the cutting jaws for cutting.

FIGS. 20A-20E are views of the cutting plier closing at various stages to operate or cut on the wire of FIGS. 19A-19B.

FIG. 21 is a perspective view of a cutting plier device according to a second embodiment of the present invention.

FIG. 22 is an exploded view of the cutting plier of FIG. 21.

FIG. 23 is a perspective view of a cross-section of the cutting jaw of FIG. 21.

FIG. 24 is a perspective view of a tension link cross-section of cutting jaw of FIG. 21.

FIG. 25 is a perspective view of a compression link cross-section of cutting jaw of FIG. 21.

FIG. 26 is a perspective view of the cutting plier of FIG. 21.

FIG. 27 is a graphical view of direction forces conveyed by the cutting plier.

FIG. 28 is a view of an Instantaneous Center of Rotation of the cutting plier.

FIG. 29 is a view of the forces applied on the cutting jaws.

FIG. 30 is another view of an Instantaneous Center of Rotation of the plier.

FIG. 31 is another view of the forces applied on the cutting jaws.

FIG. 32 is an illustration of instantaneous centers of rotation of the multi-bar linage of the cutting plier.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### V. DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

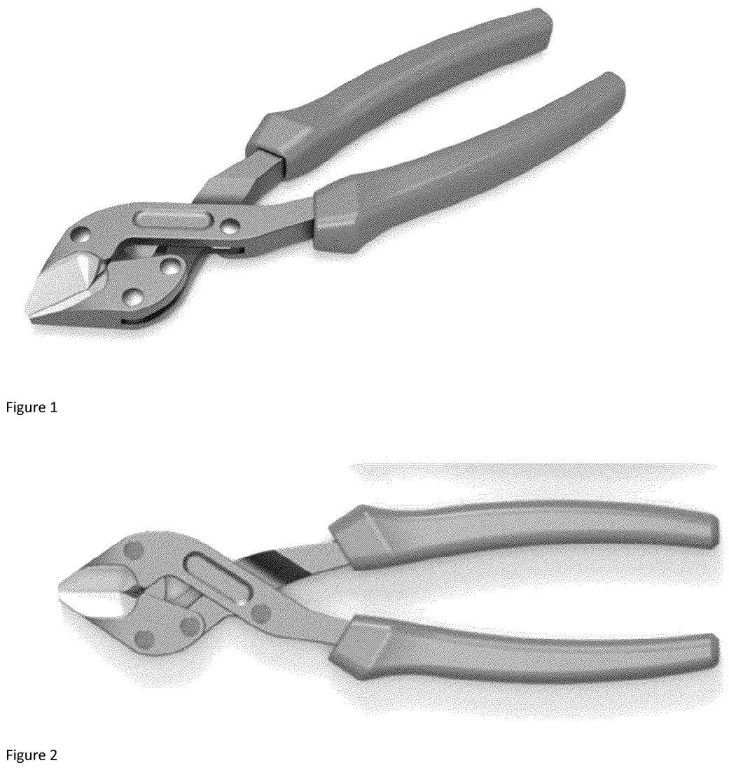

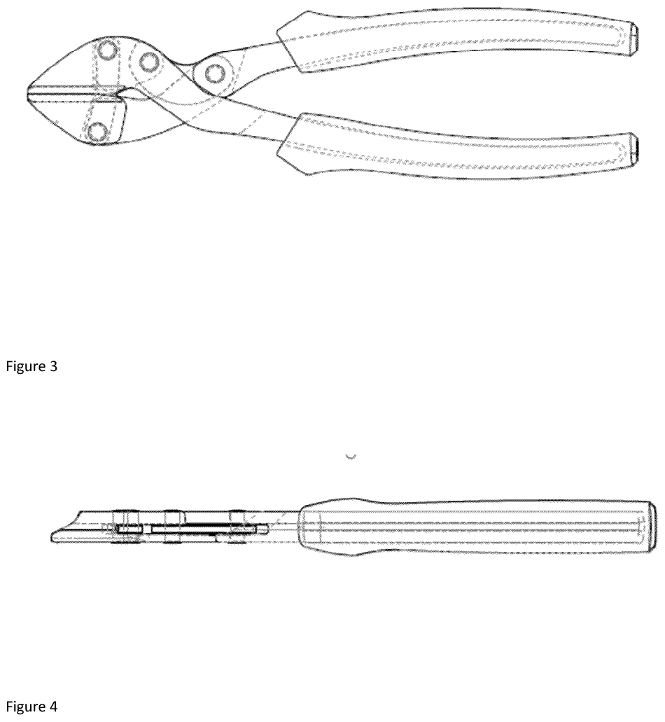

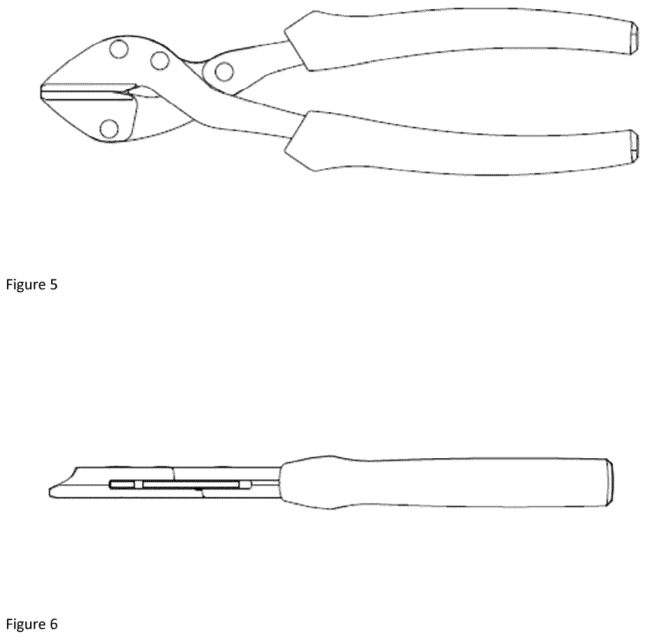

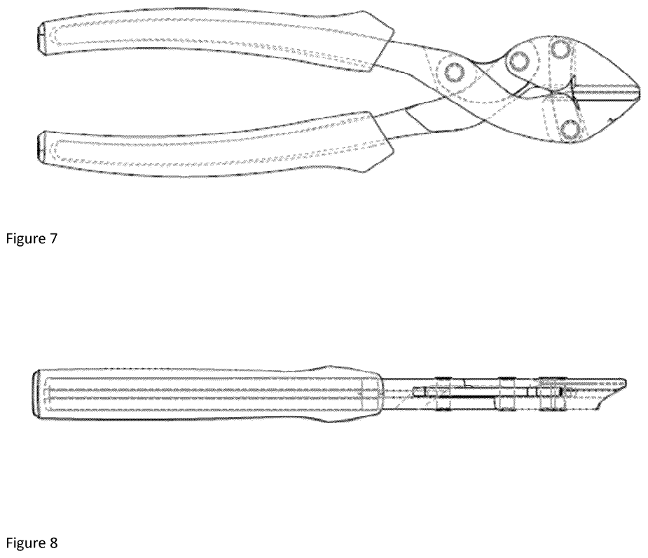

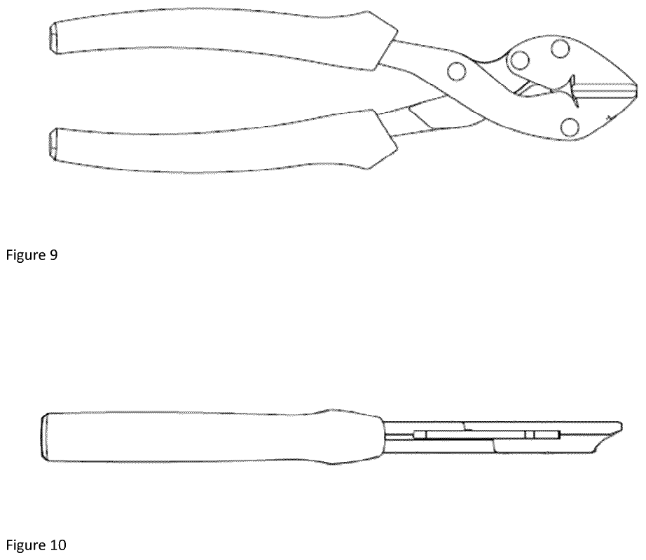

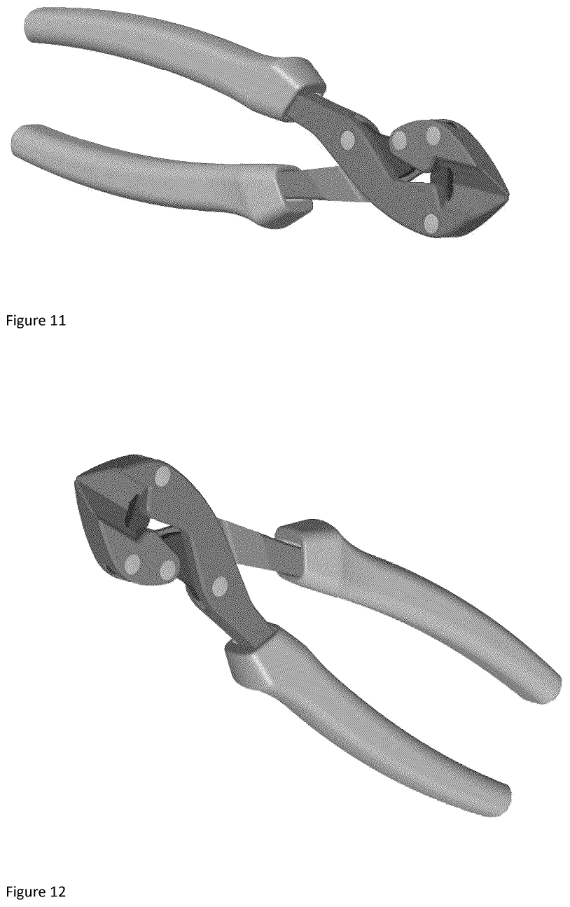

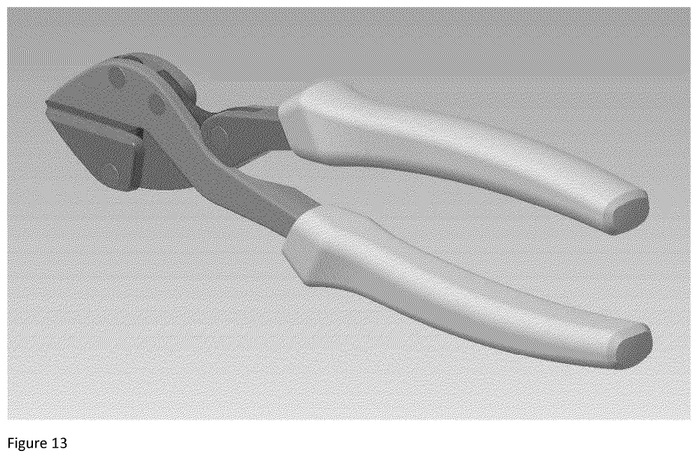

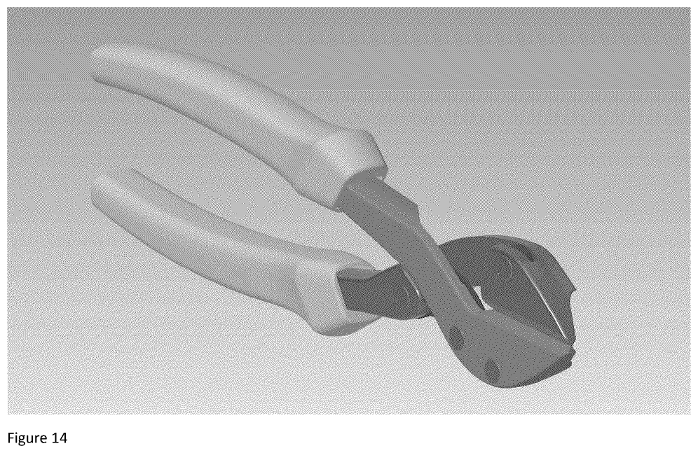

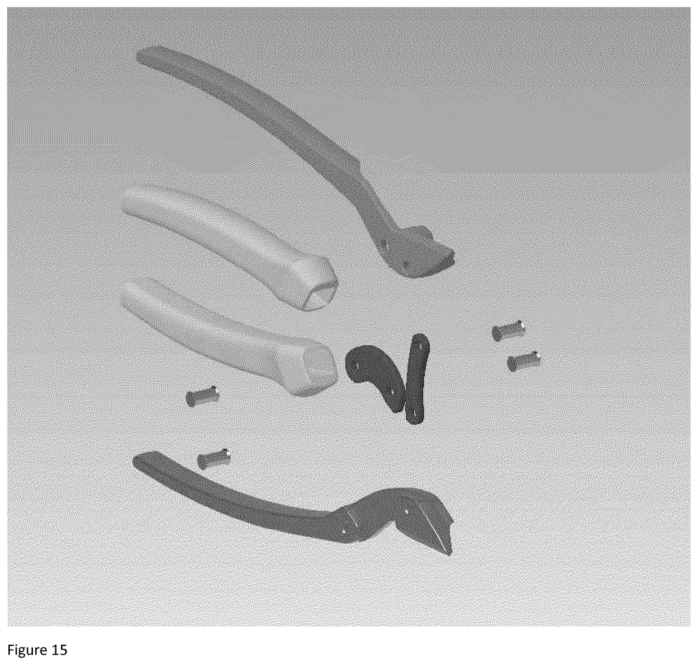

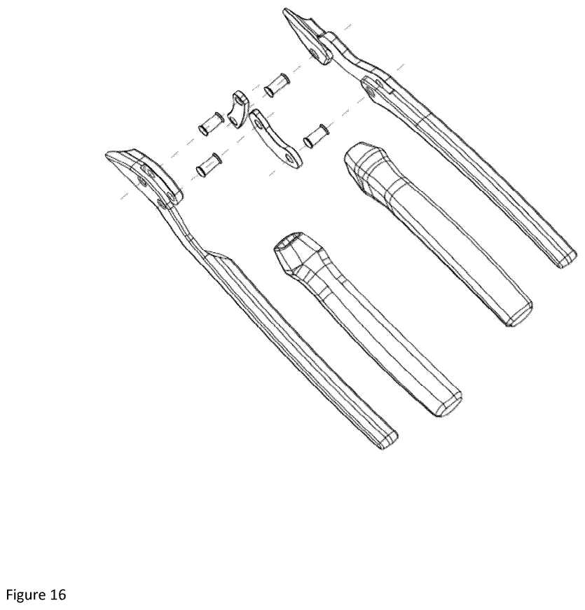

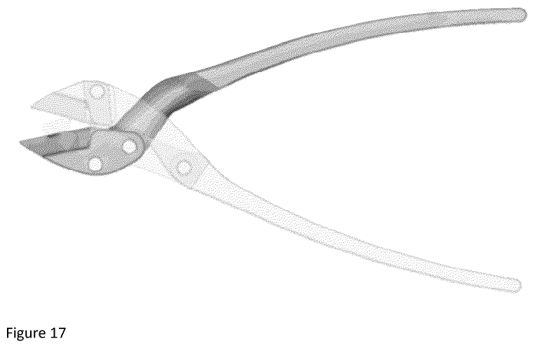

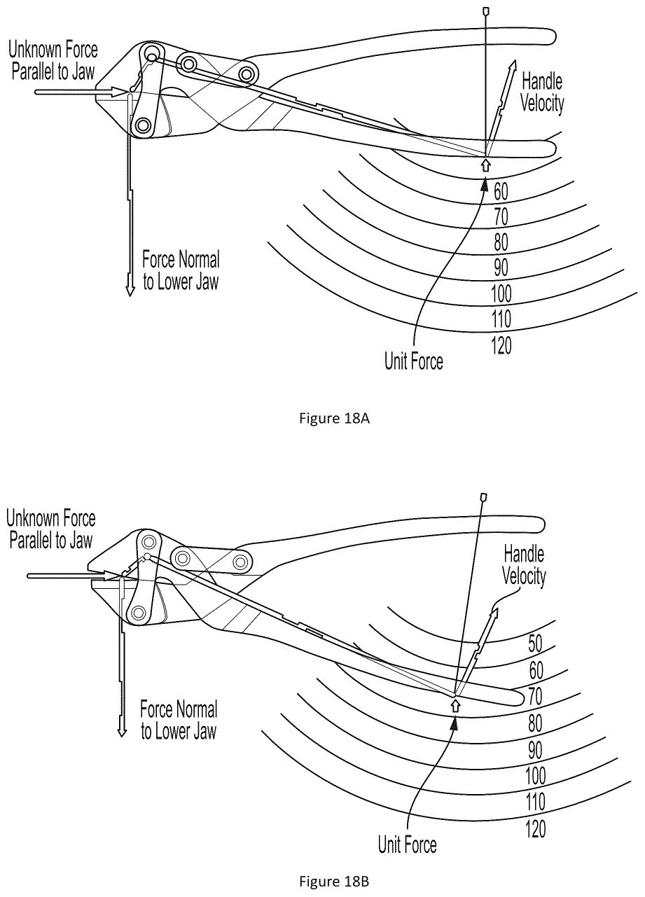

Referring to FIGS. 1-16, there is shown and described perspective and exploded views, of a cutting plier device 10 according to a first embodiment of the present invention. In this Figure the cutting plier device includes handles, compression links, tension links, back links, a number of pivot or pins, front links, and grip handles. FIGS. 1-17 illustrate both modeled views, cross-sectioned images, and exploded views of the multi-link cutting plier.

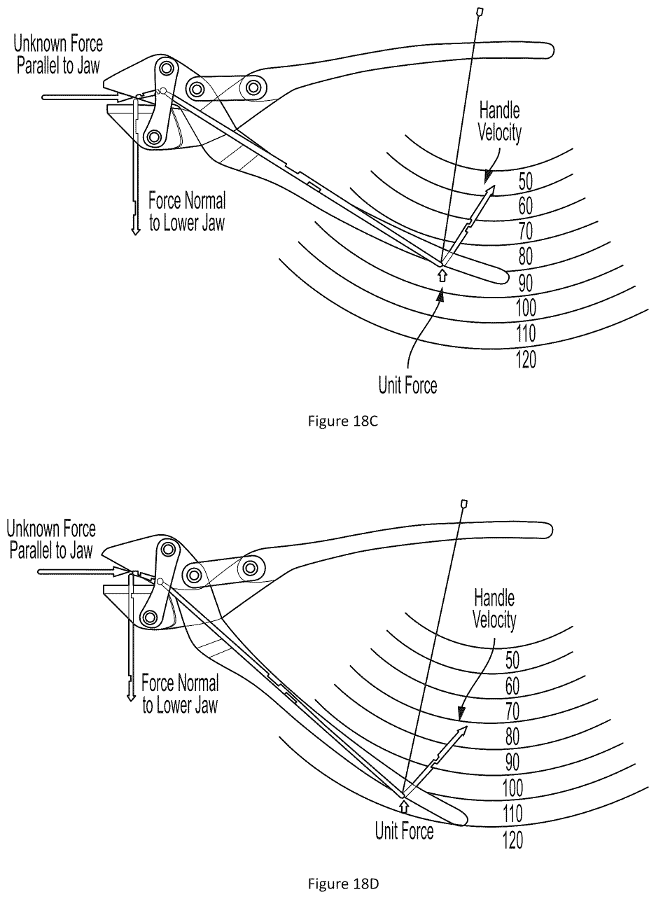

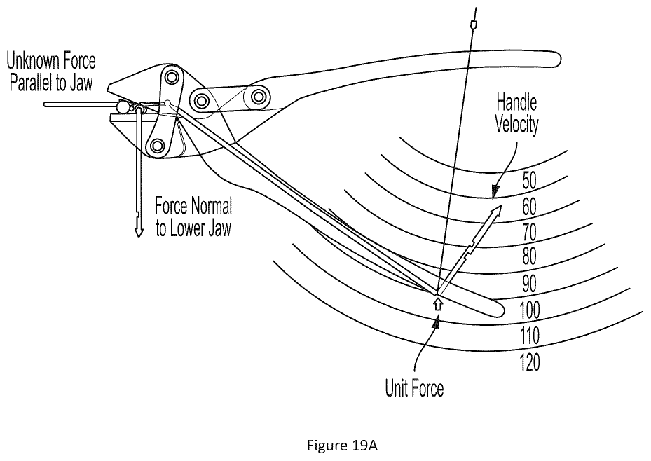

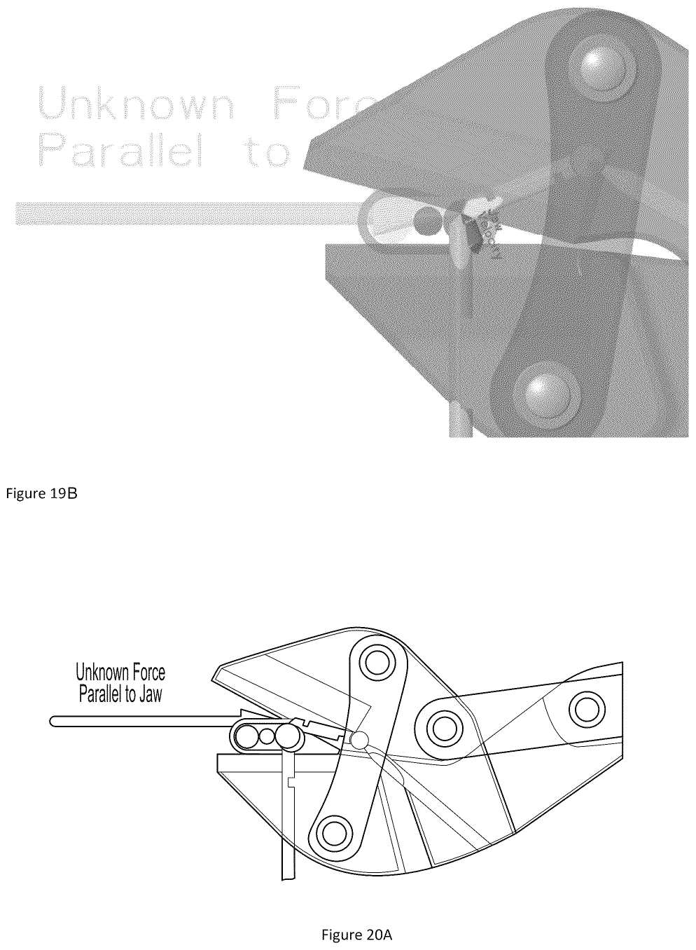

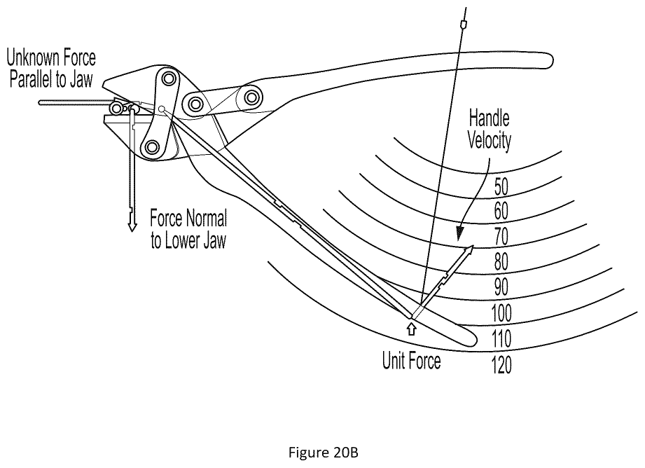

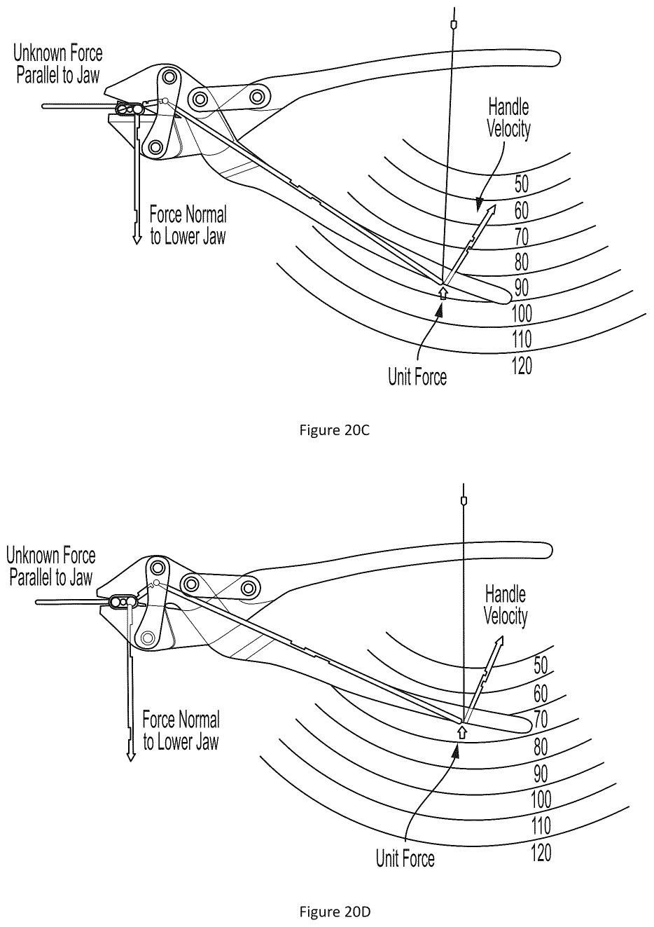

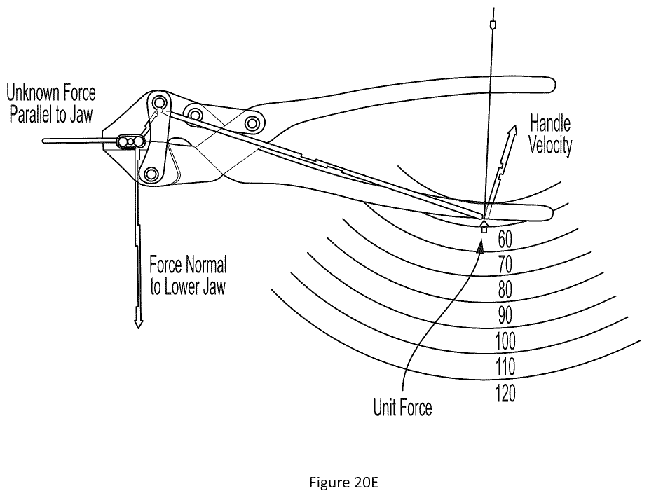

Considering FIGS. 18A-18D, FIGS. 18A-18D are views of the cutting plier opening at various stages to operate or cut on a wire, pipe, cable, tube, chain and the like. FIGS. 19A-19B are views of the cutting plier having a wire between the cutting jaws for cutting. FIGS. 20A-20E are views of the cutting plier closing at various stages to operate or cut on the wire of FIGS. 19A-19B.

As shown in FIGS. 18A-20E, the linkages used to control the relative motion of the jaws and/or used to control the cutting edge of the jaws. FIGS. 18A-18E includes a tool having a top jaw/bottom handle component referred to as the top jaw and a bottom jaw/top handle component that can be referred to as the bottom jaw. The tool also includes two links, each having one or more leaves or laminations. One link is referred to as the tension link (or transverse link). The other link is referred to as the longitudinal link (or compression link).

As shown in the Figures, the tool can includes said two jaws connected by said two links. In at least one embodiment of the present invention, one end of each link is rotatably connected to the top jaw. The other end of each link is rotatably connected to the bottom jaw. Each of these four connections can have pure rotation between the respective jaw and the respective link.

At least two links can be described to have a line of action, a straight line perpendicular to and intersecting with the axis of rotation at each end of said link. This line of action can extend beyond the ends of the links. One point of intersection between the line of action of the tension link and the line of action of the compression link may define the momentary center (also referred to as instantaneous center) of rotation of all parts of the mechanism. The momentary center of rotation moves as the mechanism is articulated resulting in a motion between the top jaw and the bottom jaw that may not be the pure rotation as generally described above, but may include a combination of rotation and translation.

For example, fixing the top jaw/bottom handle allows the mechanism to be articulated by moving the bottom jaw/top handle. Articulating the mechanism results in the bottom jaw moving, relative to the top jaw, by rotating about the moving instantaneous center. As stated generally above, the resulting motion may not be pure rotation, but may be a combination of rotation and translation.

For example, a closing motion of said bottom jaw causes the edge of the bottom jaw to approach the top jaw and translate along the top jaw. This can result in a combination of pinching action and slicing action on the item being cut. The combination of pinching action and slicing action is a novel and effective way to accomplish cutting a variety of materials efficiently.

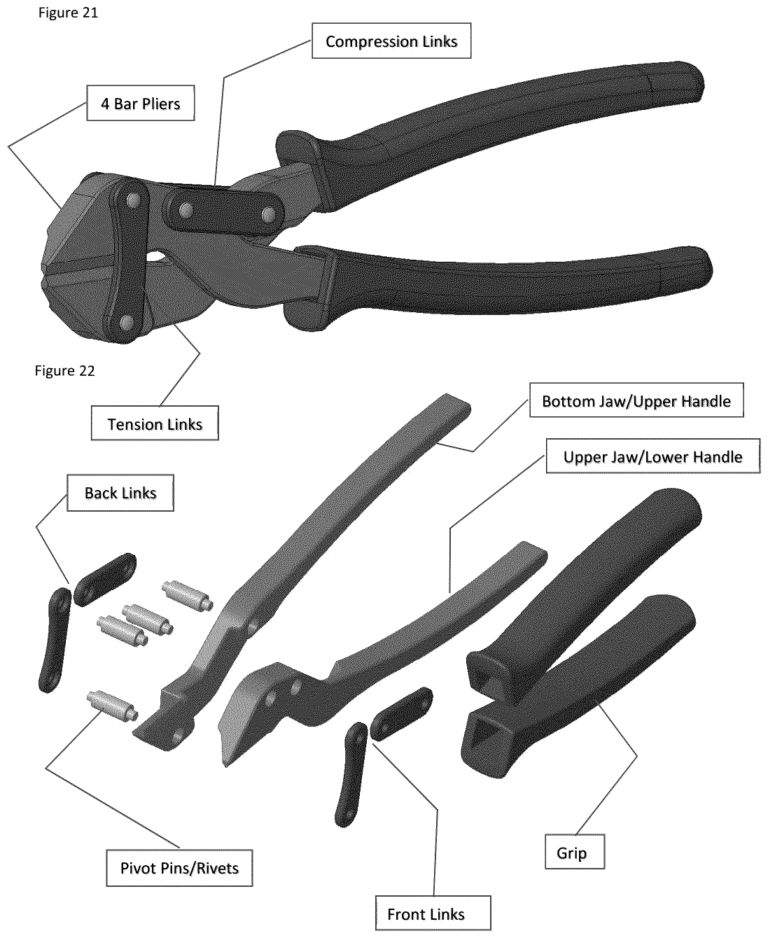

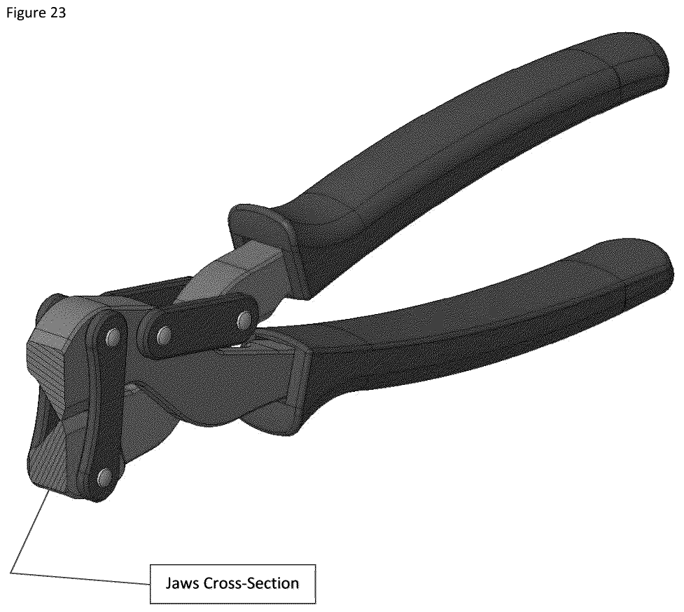

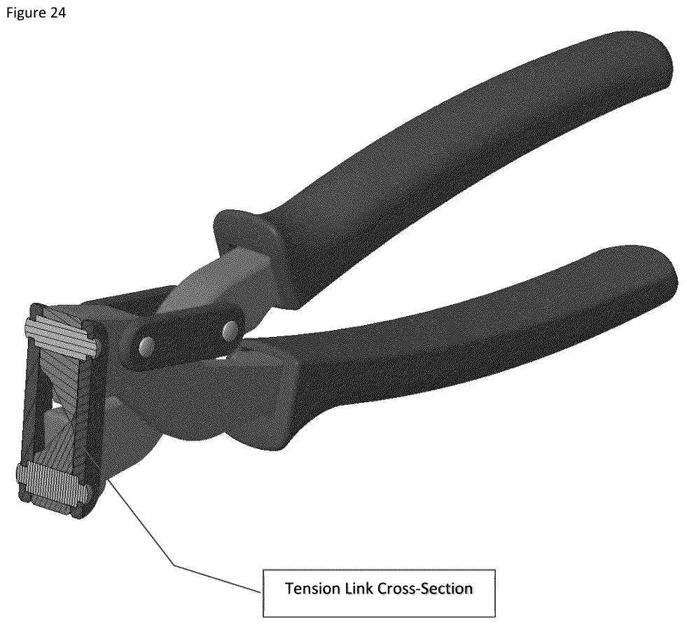

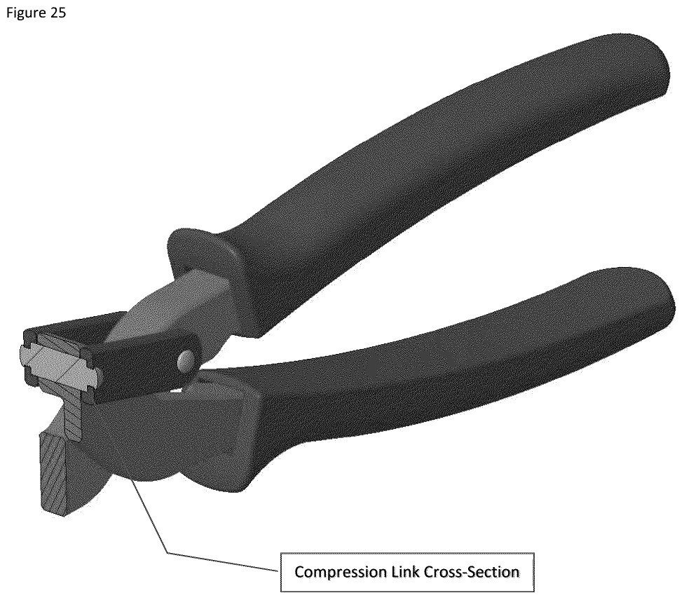

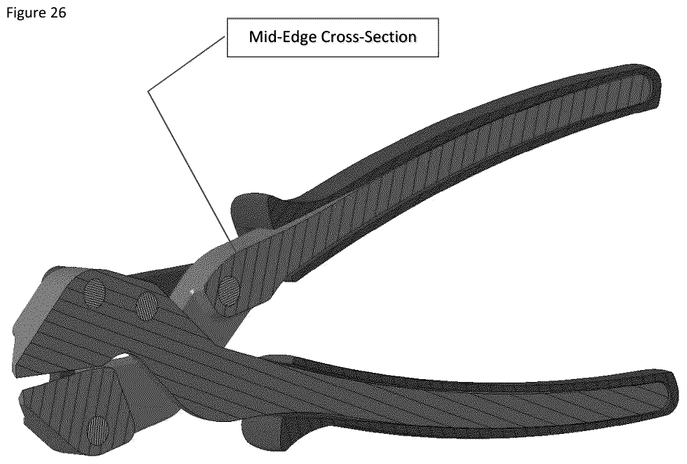

Now referring to FIGS. 21-26, there is shown and described perspective and exploded views, of cutting plier device 10 according to a second embodiment of the present invention. In these Figures the cutting plier device includes handles, compression links, tension links, back links, a number of pivot or pins, front links, and grip handles.

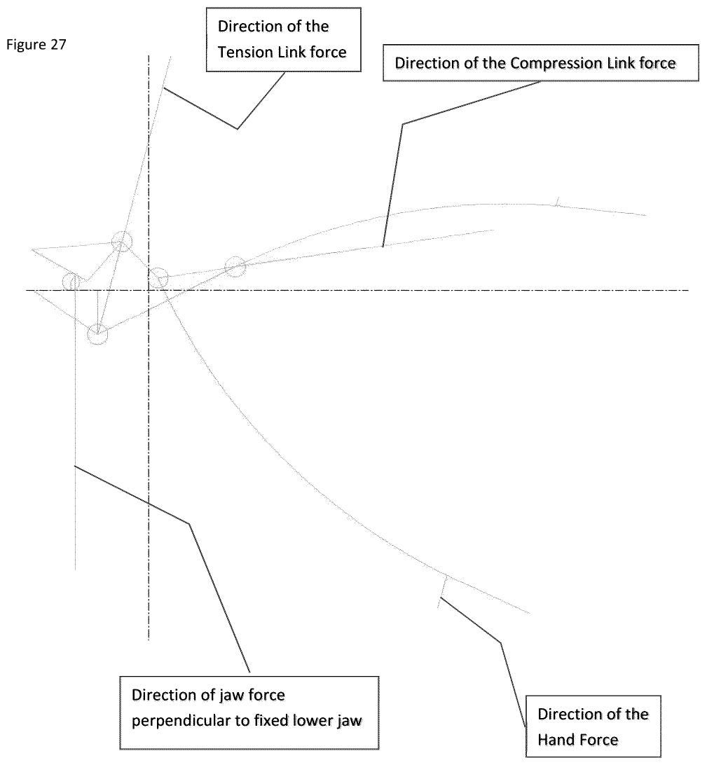

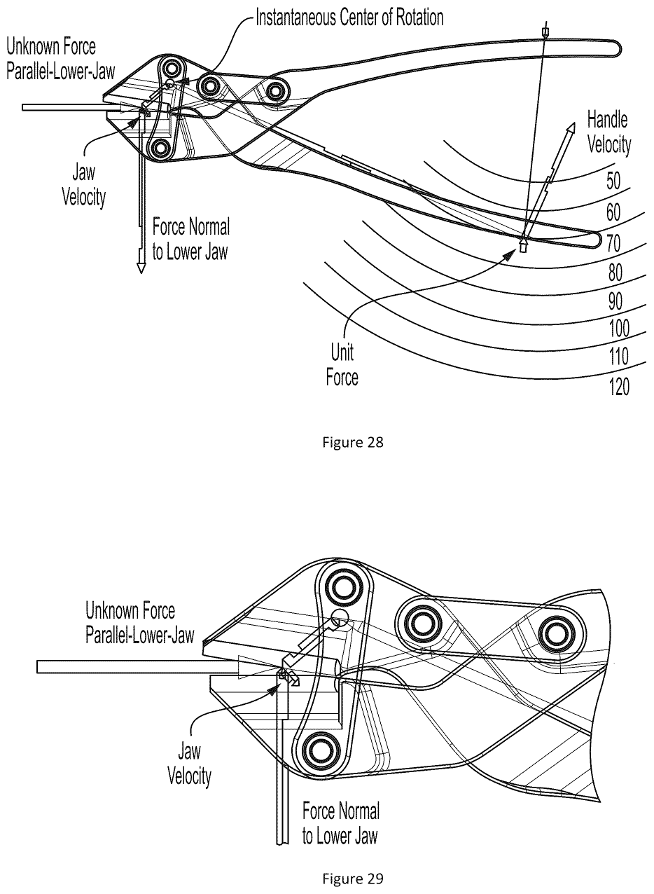

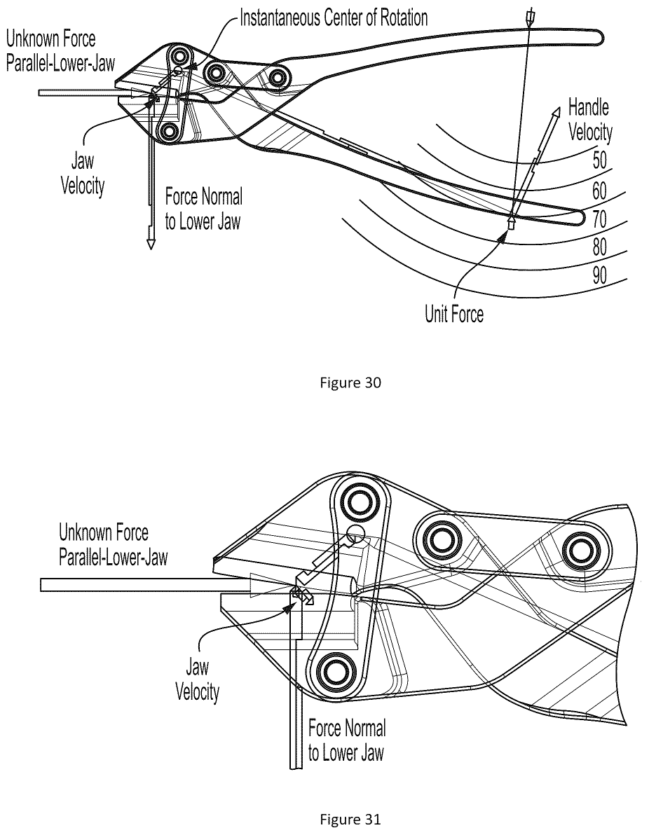

Referring to FIGS. 27-32 there is Depicted and described are direction forces applied on the cutting jaws including the direction of the tension Link force, direction of the compression link force, and direction of jaw force perpendicular to fixed lower jaw, such as shown in FIG. 27.

### Instantaneous Centers of Rotation

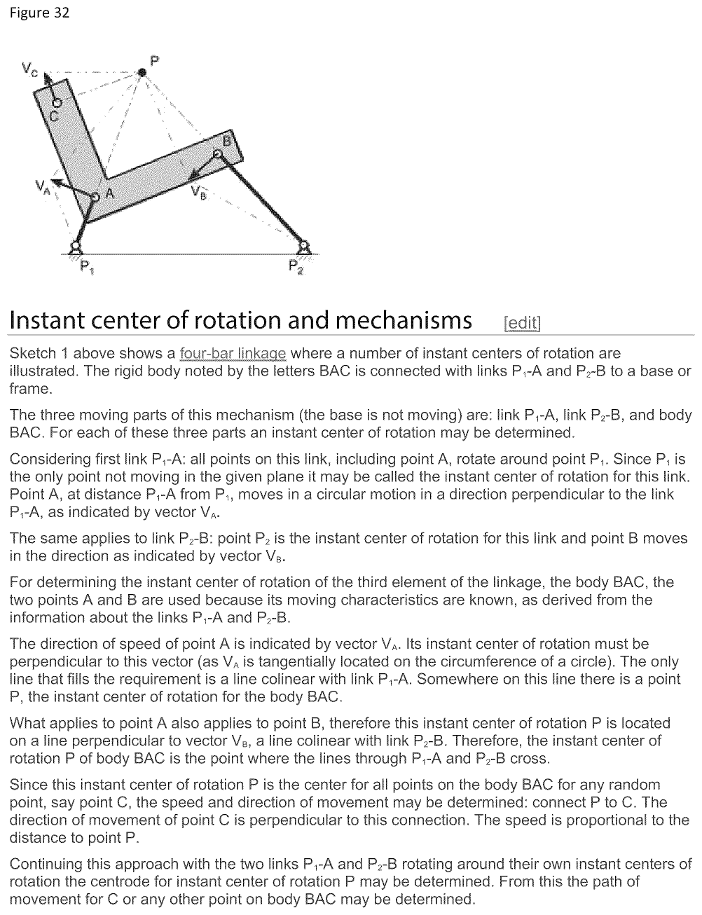

As shown in the illustrations of the instantaneous centers of rotation of the multi-bar linage of the cutting plier. For example, FIG. 32 there is illustrated and described the rigid body noted by the letters BAC and is connected with links P1-A and P2-B to a base or frame. There can be three moving parts of this mechanism (the base is not moving) are: link P1-A, link P2-B, and body BAC. For each of these three parts an instant center of rotation may be determined.

Considering a first link P1-A: all points on this link, including point A, rotate around point P1. As P1 is the only point not moving in the given plane it may be called the instant center of rotation for this link. Point A, at distance P1-A from P1, moves in a circular motion in a direction perpendicular to the link P1-A, as indicated by vector VA.

The same applies to link P2-B: point P2 is the instant center of rotation for this link and point B moves in the direction as indicated by vector VB. In assisting in determining the instant center of rotation of the third element of the linkage, the body BAC, the two points A and B may be used as its moving characteristics are known, as derived from the information about the links P1-A and P2-B.

The direction of speed of point A can be indicated by vector VA. Its instant center of rotation may be perpendicular to this vector (as VA is tangentially located on the circumference of a circle). The line that fills the requirement is a line colinear with link P1-A. On this line there is a point P, the instant center of rotation for the body BAC.

What applies to point A also applies to point B, therefore this instant center of rotation P is located on a line perpendicular to vector VB, a line colinear with link P2-B. Therefore, the instant center of rotation P of body BAC is the point where the lines through P1-A and P2-B cross. Since this instant center of rotation P is the center for all points on the body BAC for any random point, say point C, the speed and direction of movement may be determined: connect P to C. The direction of movement of point C is perpendicular to this connection. The speed is proportional to the distance to point P. Continuing this approach with the two links P1-A and P2-B rotating around their own instant centers of rotation the centrode for instant center of rotation P may be determined. From this the path of movement for C or any other point on body BAC may be determined.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

We claim:

1. An improved multi link cutting plier comprising:
a plurality of connecting linkages that can include a number of connecting members or links;
the plurality of linkages including a first link at one end that is connected to the first handle and at the other end to a pivot pin;
a second link at one end is connected to the second handle and at the other end to the same pivot pin as the first link;
a third link that is connects the pivot pin with the end of the first jaw member which is away from the cutting edge.
a fourth link connects the pivot pin with the end of the second jaw member which is away from the cutting edge.

2. The improved cutting plier of claim 1, wherein the four links can all be fixed at one end to either the handle or the jaw member to which they are attached but can pivot about the pivot pin to which the other ends are attached.

3. A multi-link cutting tool comprising:
a cutting jaw;
a first and second handle, each of which is held in position and pivots about an area of the cutting jaw;
a number of connecting linkages between each handle; and
the cutting jaws including a first link connecting the first handle and a pivot pin, a second link connecting the second handle and a pivot pin, and a third link connecting to a pivot pin, and a fourth link connecting a pivot pin.

4. The multi-link cutting tool of claim 3, wherein the number of connecting links can all be fixed at one end to either the handle or the jaw member to which they are attached but can pivot about the pivot pin to which the other ends are attached.
